(19) United States
(12) Patent Application Publication
(10) Pub. No.: US 2008/0021827 A1
(43) Pub. Date: Jan. 24, 2008

(54) Method for paying funds not covered by medical insurance using a card

(76) Inventor: Edward Willis, Bowling Green, OH (US)

Correspondence Address: Edward Willis, 806 Greystone Dr., Bowling Green, OH, 43402, US

(21) Appl. No.: 11/904,052

(22) Filed: Sep. 26, 2007

Related U.S. Application Data
(63) Continuation-in-part of application No. 11/825,166, filed on Jul. 5, 2007.
(60) Provisional application No. 60/806,636, filed on Jul. 6, 2006.

(51) Int. Cl. G06Q 40/00; G06Q 50/00

(52) U.S. Cl. 705/41

(57) ABSTRACT

A method and a means comprising a card with an encoded magnetic stripe or microprocessor that allows funds to be transferred from the card issuer to a medical service provider. The card would allow an insured person to prepay funds to be used for medical services rendered.

### BACKGROUND OF THE INVENTION

Traditionally, medical insurance plans cover only a portion of the total fee for a doctor's visit, a consultation by a specialist, or a prescription. The remaining funds, also known as copay, are paid by the insured after the examination. As healthcare costs have increased insurance companies have offset their costs by decreasing benefits. Many times the decision to decrease benefits has then resulted in the insured having his copay increased forcing the insured to carry large sums of cash or the medical service provider to accept a check without verification that sufficient funds exist to cover it.

Cards that can store information and are used for medical and healthcare management functions have been reported in the patent literature.

U.S. Pat. No. 5,884,271 describes a universal electronic transaction card that includes storage elements, an input interface, a processor, a display, and a communications interface. Uses mentioned for the card include storing patient medical information.

U.S. Pat. No. 5,583,760 describes a data processing system that establishes and administers charge accounts, including both funded and post-funded accounts. The system establishes charge accounts for all of the patients of a medical professional, in which each patient is issued a charge card which can be used to pay for medical services.

Additionally, U.S. Pat. No. 6,208,973 describes a point of service transaction system which designates the portion of the service to be paid by a third party payer and the portion to be paid by the customer. The system comprises a point of service terminal which accepts a payment system access card. The point of service terminal creates a purchase transaction which is adjudicated by an adjudication engine to determine a first portion of the purchase which is to be paid by the third party payer and a second portion of the purchase which is to be paid by the customer. The payment system access card provides access to a payment system which transfers funds in accordance with the adjudicated settlement transaction whereby the third party payer is debited the first portion, a payment account accessible by the access card is charged at least the second portion, and the point of service provider is paid both portions. Healthcare service providers are mentioned as possible users of the system.

Methods to accelerate the payment from an insurance company to a medical service provider through use of a smart card also exist. U.S. Pat. No. 6,820,058 describes a method for creating a smart card, transmitting information between the insurance provider and medical service provider, and transferring payment from the insurer to the service provider.

It would thus also be desirable to have method and or card for storing and transmitting an insured party's medical and personal information, that could be universally used, and would allow the insured party to prepay funds for expenses not covered by their insurance plan. Those funds could then be transferred to a medical service provider for the amount of copay owed after a service or procedure was rendered.

### BRIEF SUMMARY OF THE INVENTION

The present invention allows insured persons, such as patients or pet owners, to prepay funds to a card issuer and then transfer funds to a medical service provider that are not covered by their insurance plans to cover their costs or those of their pets.

The present invention is a method for paying a copay amount, comprising: providing a card capable of storing information; encoding information on the card, the information including the cardholder's account balance, and at least one copay term of the cardholder's insurance coverage; using a transaction terminal to transmit or encode the information or both; comparing the cardholder's account balance to the copay amount; and if the account balance is greater than the copay amount, transferring funds from the cardholder's account to the account of the medical service provider to cover the copay amount.

The present invention is also a card that is used for paying the amount due by a insured party as part of a transaction the cost of which is covered in part by insurance, comprising: a magnetic strip or a microprocessor or both used for transferring funds to and from the insured's account, storing encoded information including at least one copay term of the insurance coverage and the account balance, and transferring the information and copay funds to a medical service provider using a transaction terminal.

The card may also comprise: a magnetic strip or a microprocessor or both used for transferring funds to and from the insured's account, storing encoded information including at least one copay term of the insurance coverage and the account balance, and transferring the information and copay funds to a medical service provider using a transaction terminal; a first major surface with at least one or more of the insured's name, address, or photo identification; and a second major surface with a space for a signature.

The present invention allows funds to be transferred from the card issuer to the service provider and utilizes information such as the copay amount, the amount of money on the card or account balance, and security controls to eliminate the patient's need for carrying cash or a checkbook to cover his expenses. The invention also prevents the insured from going into debt when a payment is made or incurring a penalty for exceeding his account's value because only funds already credited to the cardholder may be transferred.

Additional features can include allowing the cardholder to authorize an overdraft option, preventing card balance deductions for limited activity over an extended period of time, and or allowing the cardholder's employer to add funds to the card either at the request of the cardholder or for purposes of reward. Last, the invention may also include patient information comprising current medications, allergies, and their primary physician's name which could prevent serious medical harm before treatment is administered in the case of an emergency.

### DETAILED DESCRIPTION OF THE INVENTION

The present invention is, primarily, a prepaid debit card and method for transferring funds to cover copay costs.

The method comprises providing a magnetically encoded card or a card which contains a microprocessor, a smart card, or both to store patient and insurance coverage information and to transfer funds to a medical service provider and using a credit, debit, smart, or dual card terminal to encode the card with the insured's insurance plan and or medical information, to credit funds to the account, to read the encoded information, and to transfer funds or information to a medical service provider.

The card utilizes an encoded magnetic strip or a microprocessor or both to store information related to the amount of copay the insured owes depending on the medical service or device rendered and the nature of the coverage. The card may have both a magnetic strip and a microprocessor for use when a doctor's office has only one type of terminal or a dual terminal. The card provides the patient or pet owner the advantage of eliminating the need for additional identification, information, and money usually required before or after treatment. Thus, the card comprises at least one means for storing information such as a magnetic strip or microprocessor capable of transferring funds from the insured cardholder to a medical service provider.

The card can be of a generalized nature so that none of the insured's personal information is encoded except the insured's copay amount and the funds credited to the insured's card account. The card could also be encoded with personalized information on either or both the magnetic strip and microprocessor. Personal information such as the insured's name, their primary physicians name, current medications, address, height, weight, allergies, employer information, insurance provider, copay amounts, card balance, insured's signature, a PIN number, and photo identification could all be encoded. Additionally, personalized information and or additional security controls could also be added onto the surface of the card and or encoded onto the magnetic strip or microprocessor.

In a magnetic strip embodiment the strip would be located on the back of the card, like standard credit or debit cards, where a signature may also be found if the card is personalized with the insured's information. In a smart card containing microprocessor embodiment the microprocessor is located on the inside of the card and is typically embedded under a gold or metallic contact on one side of the card. The card could also comprise both a magnetic strip and a microprocessor.

The card acts as debit card in that when a transaction occurs the copay amount is deducted from an account equal to the balance on the card. Therefore, the maximum value of the account is set by the amount credited to the card. When the card value decreases after one or several transactions the card can be reloaded or credited with additional funds through the original entity where the card was purchased or through direct deposit into the cardholder's account from the cardholder's financial institution.

Initially, funds would be received by an entity or institution capable of crediting funds to the card, encoding the copay amount, and adding any other personal and or security information onto the magnetic strip or microprocessor. When the card is used or swiped any of the following information could be transmitted: the copay amount, the copay amount requested, the funds available on the card, a check of the insured's eligibility, an acknowledgment of the services rendered, a transmission and or receipt acknowledging the amount transferred, and a quick transfer and debit of the funds from the account.

The card could also provide several security features. First, any request for funds that is greater than the balance would be denied. Additionally, the card could be encoded with a PIN number to prevent unauthorized use and each transaction could require a signature to prevent fraud.

The present invention thus completely eliminates the insured party's need for additional identification, information, and cash before or after medical treatment. It also protects the insured from paying penalties for funds not already purchased and loaded onto the card. The card would be universally accepted because it could be used anywhere a medical service provider and transaction terminal such as a credit, debit, or smart card scanner is located. The card provides a secure prepaid means for paying medical expenses not covered by insurance coverage.

Finally, the invention has been disclosed in which is considered to be its preferred embodiments. It must be understood, however, the specific embodiments are provided only for the purpose of illustration, and that the invention may be practiced otherwise than as specifically illustrated without departing from its spirit and scope.

What is claimed is:

1. A method for paying a copay amount, comprising:
providing a card capable of storing information;
encoding information on the card, the information including the cardholder's account balance, and at least one copay term of the cardholder's insurance coverage;
transmitting the information to a medical service provider;
comparing the cardholder's account balance to the copay amount; and
if the account balance is greater than the copay amount, transferring funds from the cardholder's account to the account of the medical service provider to cover the copay amount.

2. The method for paying copay as recited in claim 1, wherein the information encoded on the card is stored using a magnetic strip or a microprocessor or both.

3. The method for paying copay as recited in claim 2, wherein the information encoded on and capable of being transmitted by the card further compromises one or more of the insured's name, current medications, address, height, weight, allergies, photo identification, employer information, primary physician's name, insurance provider, copay amount, card balance, or PIN number.

4. The method for paying copay as recited in claim 3, wherein a transfer of funds to a medical service provider is prevented when the card balance is less than the copay amount.

5. A card used for paying the amount due by a insured party as part of a transaction the cost of which is covered in part by insurance, comprising:
a magnetic strip or a microprocessor or both; and
at least one copay term of the insurance coverage and the account balance encoded on the magnetic strip, microprocessor, or both.

6. The card as recited in claim 5, wherein funds may not be transferred to a medical service provider when the insured's account balance is less than the amount of the copay term associated with the medical service rendered.

7. The card as recited in claim 6, wherein the stored encoded information further comprises one or more of the insured's name, home address, current medications, photo identification, height, weight, allergies, primary physicians name, employer information, insurance provider, or PIN number.

8. A card used for paying the amount due by a insured party as part of a transaction the cost of which is covered in part by insurance, comprising:
a magnetic strip or a microprocessor;
at least one copay term of the insurance coverage and the account balance encoded on the magnetic strip, microprocessor, or both;
a first major surface with at least one or more of the insured's name, address, or photo identification; and
a second major surface with a space for a signature.

9. The card as recited in claim 8, wherein funds may not be transferred to a medical service provider when the insured's account balance is less than the amount of the copay term associated with the medical service rendered.

10. The card as recited in claim 9, wherein the stored encoded information further comprises one or more of the insured's name, home address, current medications, photo identification, height, weight, allergies, primary physicians name, employer information, insurance provider, or PIN number.
